(19) United States
(12) Patent Application Publication
(10) Pub. No.: US 2006/0043898 A1
(43) Pub. Date: Mar. 2, 2006

(54) Electric incandescent lamp

(75) Inventors: Frank Auer, Bolheim (DE); Christian Seichter, Herbrechtingen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 11/199,388

(22) Filed: Aug. 9, 2005

(30) Foreign Application Priority Data
Aug. 24, 2004 (DE) 10 2004 041 113.1

(51) Int. Cl. H01J 17/18

(52) U.S. Cl. 313/623

(57) ABSTRACT

The invention relates to an electric incandescent lamp, in particular a vehicle headlight lamp, having an incandescent filament, arranged inside a transparent lamp vessel, and supply leads for the incandescent filament, at least one of the supply leads being provided with at least one reinforcing strut in order to improve the vibration strength of the lamp.

### I. TECHNICAL FIELD

The invention relates to an electric incandescent lamp having an incandescent filament, arranged inside a transparent lamp vessel, and supply leads for the incandescent filament, and supporting means for the supply leads.

### II. BACKGROUND ART

Such an incandescent lamp is disclosed, for example, in laid-open application DE 21 05 155. This document describes a tungsten halogen lamp for projection purposes whose incandescent filament is connected to supply leads that are surrounded in each case by a support body. One end of these support bodies is embedded in each case in the sealed end of the lamp vessel. The support bodies are designed as coils. It has emerged that it is impossible with the aid of such support bodies to achieve an adequate vibration strength for incandescent lamps that are used in vehicle headlights.

### III. DISCLOSURE OF THE INVENTION

The object is to provide an electric incandescent lamp having increased vibration strength.

This object is achieved according to the invention by an electric incandescent lamp having an incandescent filament, arranged inside a transparent lamp vessel, and supply leads for the incandescent filament, and a supporting means for the supply leads being provided, wherein the supporting means is designed as at least one strut for at least one of the supply leads. Particularly advantageous designs of the invention are described in the dependent patent claims.

The electric incandescent lamp according to the invention has an incandescent filament, arranged inside a transparent lamp vessel, and supply leads for the incandescent filament, at least one of the supply leads being provided with at least one strut. By contrast with the support body, designed as a coil, in accordance with the prior art, the at least one strut effects a reinforcement of the supply lead equipped with it. For example, supply lead sections that are bent or angled away are bridged by the at least one strut. As a result, in the case of vibrations the amplitude of the deflection of the incandescent filament from its equilibrium position is reduced, and the vibration strength of the incandescent lamp is increased.

In the case of incandescent lamps such as, for example, vehicle headlight lamps, that are equipped at one end with a base, and in the case of which the incandescent filament has a filament outgoing feeder near the base and a filament outgoing feeder remote from the base, at least the supply lead connected to the filament outgoing feeder remote from the base is advantageously equipped with the at least one strut, since this supply lead has a low vibration strength because of its relatively long length. In accordance with the preferred exemplary embodiment of the invention, the abovenamed supply lead is equipped with a strut that is connected at at least three points to the supply lead remote from the base.

In order to effect an adequate reinforcement of the at least one supply lead, the at least one strut is connected at at least two points to the at least one supply lead. The at least one strut is preferably designed as a wire in order to keep the shading of the light caused by the strut within acceptable limits.

### IV. BRIEF DESCRIPTION OF THE DRAWINGS

The invention is explained in more detail below with the aid of a preferred exemplary embodiment. In the drawing:

FIG. 1 shows a schematic side view of an incandescent lamp in accordance with the preferred exemplary embodiment of the invention, and

FIG. 2 shows the incandescent filament of the incandescent lamp depicted in FIG. 1 together with the supply leads and the strut.

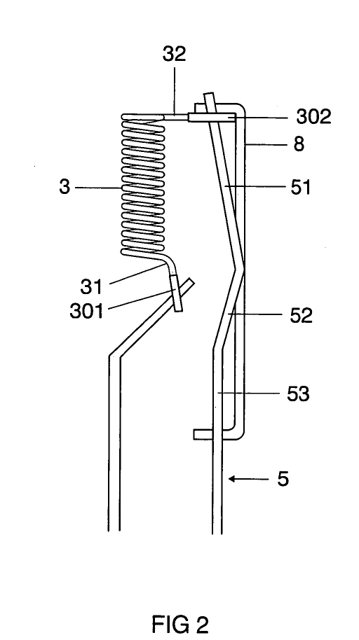

### V. BEST MODE FOR CARRYING OUT THE INVENTION

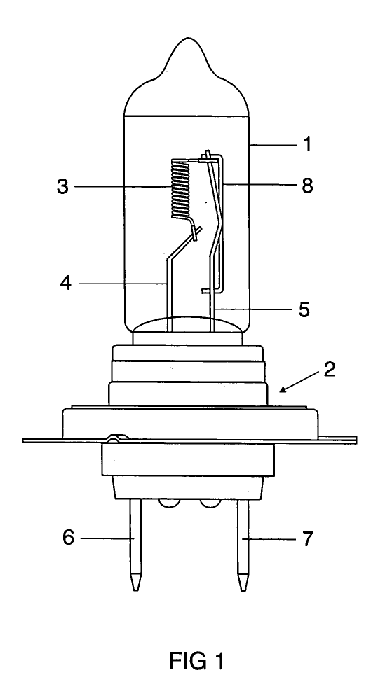

The incandescent lamp according to the invention depicted in FIG. 1 is a tungsten halogen lamp for a vehicle headlight, in particular an H7 lamp. This lamp has a vitreous, substantially cylindrical lamp vessel 1 that is provided at one end with a metallic base 2. Arranged inside the lamp vessel 1 is an axially aligned incandescent filament 3 whose filament outgoing feeders 31, 32, sheathed with a molybdenum tube 301, 302, are each welded to a supply lead wire 4, 5. The two supply lead wires 4, 5 are respectively connected in an electrically conducting fashion to an electric terminal 6, 7 of the base 2. The supply lead wire 5 connected to the filament outgoing feeder 32 remote from the base is equipped with a strut 8 that is welded at three points to the supply lead wire 5. Both the strut 8 and the supply lead wire 5 are designed as a molybdenum wire with a thickness of 0.7 mm. The strut 8 bridges a number of sections 51, 52, 53 of the supply lead wire 5 that are angled away and thereby effects a reinforcement of the supply lead wire 5. The strut 8 has two ends that are angled away perpendicularly and are welded to the section 51 or 53, respectively, of the supply lead wire 5. Moreover, the strut 8 is also welded to the transitional area between the sections 51 and 52 of the supply lead wire 5.

The invention is not restricted to the exemplary embodiment explained in more detail above. For example, it is also possible to provide the supply lead wire 4 connected to the filament outgoing feeder 31 near the base with a strut that bridges the sections of the supply lead wire 4 that are angled away. The strut 8 and the supply lead wires 4, 5 can also have a lesser thickness than 0.7 mm, for example a thickness of only 0.645 millimeters. Moreover, however, the strut 8 can also have a thickness different from the supply lead wire 5. Values in the range from 0.1 millimeter to 1.0 millimeter come into consideration for the thickness or the diameter of the strut 8.

What is claimed is:

1. An electric incandescent lamp having an incandescent filament, arranged inside a transparent lamp vessel, and supply leads for the incandescent filament, a supporting means for the supply leads being provided, wherein the supporting means is designed as at least one strut for at least one of the supply leads.

2. The electric incandescent lamp as claimed in claim 1, which is equipped at one end with a base, wherein said incandescent filament has a filament outgoing feeder near the base and a filament outgoing feeder remote from the base that are respectively connected to one of said supply leads, at least the supply lead connected to the filament outgoing feeder remote from the base being equipped with said at least one strut.

3. The electric incandescent lamp as claimed in claim 2, wherein the supply lead connected to the filament outgoing feeder remote from the base is equipped with a strut that is connected at at least three points to the supply lead remote from the base.

4. The electric incandescent lamp as claimed in claim 1, wherein the at least one strut is connected at least two points to the at least one supply lead.

5. The electric incandescent lamp as claimed in claim 1, wherein the at least one strut is designed as a wire.

6. The electric incandescent lamp as claimed in claim 2, wherein the at least one strut is connected at least two points to the at least one supply lead.
